(19) United States
(12) Patent Application Publication
(10) Pub. No.: US 2014/0176352 A1
(43) Pub. Date: Jun. 26, 2014

(54) COMPUTER KEYBOARD KEY SCAN SHARED MATRIX WITH AN INDIVIDUAL LED PER KEY

(71) Applicant: APPLE INC., Cupertino, CA (US)

(72) Inventors: Asif Hussain, San Jose, CA (US); Mohammad J. Navabi-Shirazi, Cupertino, CA (US); Jingdong Chen, San Jose, CA (US); Manisha P. Pandya, Sunnyvale, CA (US)

(73) Assignee: APPLE INC., Cupertino, CA (US)

(21) Appl. No.: 14/029,534

(22) Filed: Sep. 17, 2013

Related U.S. Application Data
(60) Provisional application No. 61/745,035, filed on Dec. 21, 2012.

(51) Int. Cl. H01H 13/83

(52) U.S. Cl. CPC H01H 13/83
USPC 341/26

(57) ABSTRACT

Systems, devices, and methods for a shared matrix of shared row pins and/or column pins between a first array of keys and a second array of lights of a keyboard. A keyboard controller addresses the first array of keys and the second array of lights during a scanning period using the shared row pins and/or column pins. Each key is backlit by one or more lights of the second array of lights that may be individually controlled. The keyboard controller may drive the desired lights of a respective row while detecting key presses of the same row during the row interval using the shared row pins and/or column pins. In some embodiments, the keyboard controller may drive the desired lights of a row during driving interval of the row interval, and scan the keys of the row separately during a sensing interval of the row interval.

### CROSS REFERENCE TO RELATED APPLICATIONS

This application is a Non-Provisional application of U.S. Provisional Patent Application No. 61/745,035, entitled “Computer Keyboard Key Scan Shared Matrix with an Individual LED Per Key”, filed Dec. 21, 2012, which is herein incorporated by reference.

### BACKGROUND

The present disclosure relates generally to a keyboard assembly for an electronic display and, more particularly, to a computer keyboard key scan shared matrix with an individual light emitting diode (LED) per key.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic devices, such as computers and laptops, are commonly used with keyboards for many different purposes, such as business, recreation, and education. Keyboards provide a user interface for inputting information and controlling the electronic device. The user presses keys on the keyboard to send input signals to a processor of the electronic device via keyboard circuitry. The keyboard circuitry detects which keys are pressed and when the keys are pressed, and it transmits appropriate input signals to the processor.

Users may utilize electronic devices, such as laptops, in different environments with various amounts of ambient light. The amount of light on the keys may affect the visibility and usability of the keyboard. Some keyboards may light the keys with backlights that illuminate the entire keyboard or regions of the keyboard with a diffuser plate to improve visibility in low light conditions. The backlight is controlled by backlight circuitry. Unfortunately, the diffuser and backlight circuitry occupy additional space around the keyboard circuitry, thus increasing the size of the keyboard. Also, the keyboard circuitry may be connected to the processor with a first quantity of pin connections, while the backlight circuitry may be connected to the processor with a second quantity of pin connections, and processors may have a limited number of available pins for pin connections.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, devices, and methods for a shared matrix of shared row pins and/or column pins between a first array of keys and a second array of lights of a keyboard. A keyboard controller addresses the first array of keys and the second array of lights during a scanning period using the shared row pins and/or column pins. That is, the keyboard controller scans the first array of keys during the scanning period to detect key presses utilizing row lines electrically connected to the shared row pins and utilizing column lines electrically connected to the shared column pins. The keyboard controller drives the second array of lights to backlight the keys utilizing the same row lines electrically connected to the shared row pins and utilizing the same column lines electrically connected to the shared column pins. In some embodiments, each key is backlit by one or more lights of the second array of lights. Each light of the second array of lights may be an individually controlled light, such as a light emitting diode (LED) or an organic light emitting diode (OLED). In some embodiments, each key of the first array of keys may be differentially backlit from the surrounding keys, enabling only desired keys to be backlit. The light for each key may be individually controlled. The keyboard controller controls the desired lights based at least in part on a user input and/or a set of instructions from a processor.

The keyboard controller may drive each row of lights separately during the scanning period to backlight the desired keys. The keyboard controller addresses each row line of the first array of keys and of the second array of lights during a respective row interval of the scanning period. The keyboard controller may simultaneously drive the desired lights on the respective row line and detect key presses on the same row line during the row interval using the shared row pins and/or column pins connected to the row lines and column lines. The keyboard controller may drive the desired lights on a row line during a portion of the respective row interval, and scan the keys on the row line separately during a remaining portion of the row interval. Adjusting the duration of the portion of the row interval used to drive the desired lights adjusts the brightness of the backlit keys.

Comparators of the keyboard controller may detect key presses during scan periods via the shared row pins and/or shared column pins. In some embodiments with shared row pins and shared column pins, each key may be in series with a resistor and/or a reverse-bias diode, and each key may be in parallel with a respective light. A relatively large resistor in series with the key may reduce a current drop through the respective parallel light when the key is pressed. A reverse-bias diode in series with the key may substantially maintain a current through the respective parallel light when the key is pressed. Pull-up resistors may be arranged with each comparator to affect the response time to detect a key press. In some embodiments, a designated comparator may detect a key press during a standby mode. The comparators may be coupled to the first array of keys and to the second array of lights via shared row pins and/or shared column pins to reduce power consumption during operation or the keyboard.

Various refinements of the features noted above may be made in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device that incorporates a keyboard with a backlight, in accordance with an embodiment;

FIG. 2 is a perspective view of an example of the electronic device of FIG. 1 in the form of a notebook computer, in accordance with an embodiment;

FIG. 3 is a front view of an example of the electronic device of FIG. 1 in the form of a desktop computer system, in accordance with an embodiment;

FIG. 4 is a block diagram illustrating a keyboard input device with a key matrix and a backlight matrix, in accordance with an embodiment;

FIG. 5 is a block diagram illustrating a first embodiment of a keyboard controller and a shared matrix for an array of keys and an array of light sources;

FIG. 6 is a timing diagram illustrating the signal timing of a scanning period for the shared matrix embodiment of FIG. 5;

FIG. 7 is a block diagram illustrating a second embodiment of the keyboard controller and the shared matrix for the array of keys and the array of light sources;

FIG. 8 is a timing diagram illustrating the signal timing of a scanning period for the shared matrix embodiment of FIG. 7;

FIG. 9 is a block diagram illustrating a third embodiment of the keyboard controller and the shared matrix for the array of keys and the array of light sources;

FIG. 10 is a timing diagram illustrating the signal timing of a scanning period for the shared matrix embodiment of FIG. 9;

FIG. 11 is a block diagram illustrating an embodiment of a key and a light source in parallel in the shared matrix;

FIG. 12 is a block diagram illustrating an embodiment of a key and a light source in parallel in the shared matrix;

FIG. 13 is a block diagram illustrating an embodiment of a key and a light source in parallel in the shared matrix;

FIG. 14 is a block diagram illustrating a fourth embodiment of the keyboard controller and the shared matrix for the array of keys and the array of light sources; and

FIG. 15 is a flowchart of a method of operating the keyboard controller to address the shared matrix, in accordance with any of the embodiments.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an example,” or the like, are not intended to be interpreted as excluding the existence of additional embodiments that also incorporate the recited features.

As mentioned above, embodiments of the present disclosure relate to a keyboard input device with a shared matrix between a first array of keys and a second array of lights. The second array of lights may be arranged to enable the keys of the first array of keys to be individually backlit. The first array of keys and the second array of lights may share row pins and/or column pins that electrically connect to a keyboard controller of the keyboard input device. The keyboard controller performs at least two actions to address the shared matrix: scanning the keys for key presses and driving the light sources to backlight desired keys. The keyboard controller addresses the shared matrix during a scanning period. The keyboard controller may divide the scanning period into row intervals to address individual rows of the first array of keys and the second array of lights. In some embodiments, during each row interval, the keyboard controller scans the keys on a row line separately from driving the lights on the row line. The keyboard controller may differentially drive the lights of the second array of lights to backlight desired keys of the first array of keys based on a user input and/or a set of instructions to the keyboard controller. The second array of lights enables each key of the first array of keys to be backlit individually. The shared row pins and/or column pins between the first array of keys and the second array of lights reduces the number of pins electrically connected to the keyboard controller, as compared to previous techniques that required a separate array of row lines and column lines for the keys and the lights.

In some embodiments, the light may remain lit while the respective key is pressed. The key switch for the key may have a resistor and/or reverse-biased diode in parallel to the light to substantially maintain a current flow through the light during a driving interval. A bypass path around the light may reduce a leakage current through the light during a key sensing interval when the respective key is pressed. A pull-up resistor may be used with a shared column pin to decrease a response time to detect a key press and/or to increase a sensitivity to detect the key press.

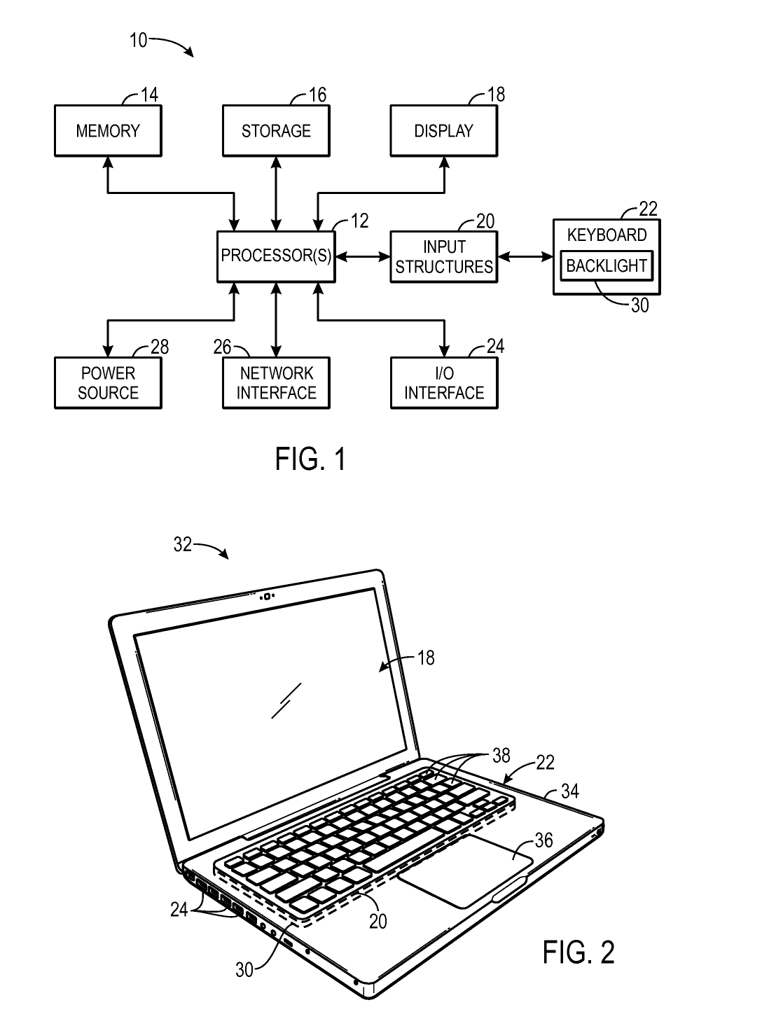

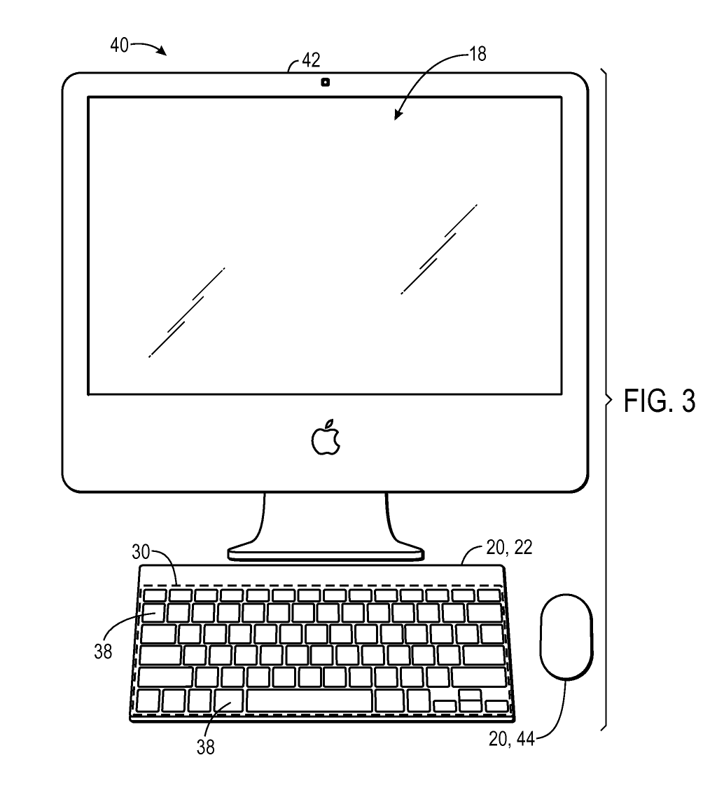

With the foregoing in mind, a general description of suitable electronic devices that may employ keyboard input devices with a shared matrix between a first array of keys and a second array of lights will be provided below. In particular, FIG. 1 is a block diagram depicting various components that may be present in an electronic device suitable for use with such an input device. FIGS. 2 and 3 illustrate various examples of suitable electronic devices in the form of a notebook computer and a desktop computer system, respectively.

Turning first to FIG. 1, an electronic device 10 according to an embodiment of the present disclosure may include, among other things, one or more processors 12, memory 14, nonvolatile storage 16, a display 18, input structures 20 including a keyboard 22, an input/output (I/O) interface 24, network interfaces 26, and a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

By way of example, the electronic device 10 may represent a block diagram of the notebook computer depicted in FIG. 2, the desktop computer system depicted in FIG. 3, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile storage 16 to execute instructions to carry out various functions of the electronic device 10. Among other things, these functions may include generating image data to be displayed on the display 18. The programs or instructions executed by the processor(s) 12 may be stored in any suitable article of manufacture that includes one or more tangible, computer-readable media at least collectively storing the instructions or routines, such as the memory 14 and/or the nonvolatile storage 16. The memory 14 and the nonvolatile storage 16 may represent, for example, random-access memory, read-only memory, rewritable flash memory, hard drives, and optical discs. Also, programs (e.g., an operating system) encoded on such a computer program product may also include instructions that may be executed by the processor(s) 12 to enable other functions of the electronic device 10.

The input structures 20 of the electronic device 10 may enable a user to interact with the electronic device 10 (e.g., pressing a key to input data to the processor, pressing a button to increase or decrease a volume level). The input structures include the keyboard 22 with a backlight 30. The backlight 30 emits light towards keys of the keyboard 22. The backlight 30 may improve visibility of the keyboard 22, provide instructions to the user, or otherwise aid the user. The display 18 may incorporate input structures 20. The display 18 may be a touch-screen liquid crystal display (LCD), for example, which may enable users to interact with a user interface of the electronic device 10. By way of example, the display 18 may be a MultiTouch™ display that can detect multiple touches at once. The display 18 may be backlit separately from the keyboard 22.

The keyboard 22 may be integrated with the electronic device 10, such as with a notebook computer, or connected separately to the electronic device 10 wirelessly or via cables. For example, a separate keyboard 22 may provide a primary or secondary input structure for a desktop computer or a handheld electronic device (e.g., tablet computer, cellular phone, portable music player). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G or 4G cellular network. In some embodiments, the keyboard 22 may connect to the processor 12 through the I/O interface 24 or the network interface 26. The power source 28 of the electronic device 10 may be any suitable source of power, such as a rechargeable lithium polymer (Li-poly) battery, alkaline battery, and/or an alternating current (AC) power converter.

The electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. of Cupertino, Calif. By way of example, the electronic device 10, taking the form of a notebook computer 32, is illustrated in FIG. 2 in accordance with one embodiment of the present disclosure. The depicted computer 32 may include a housing 34, a display 18, input structures 20, and ports of an I/O interface 24. The display 18 of the computer 32 may be a backlit liquid crystal display (LCD). The input structures 20, such as a keyboard 22 and/or touchpad 36, may be used to interact with the computer 32. An array of keys 38 on the keyboard 22 responds to physical input to receive user input. The keyboard 22 may be a contact-type keyboard or a capacitance-type keyboard. Via the input structures 20 such as the keyboard 22, a user may start, control, or operate a GUI or applications running on computer 32.

A backlight 30 below the keys 38 illuminates the keys 38 from below to improve visibility of the keyboard and/or to provide additional functionality to the keyboard. The backlight 30 is an array of lights arranged with the array of keys 38. In some embodiments, the lights of the backlight 30 are light emitting diodes (LEDs). Each key 38 may be arranged with an LED in a 1:1 ratio. Individual LEDs for each key 38 enable differential brightness levels for the keys 38. However some keys 38 may have multiple LEDs while other keys 38 have one or less LEDs. For example, a larger key (e.g., space bar, backspace) may have multiple LEDs driven together, or keys 38 may have multiple LEDs for wear balancing. In some embodiments, each LED may backlight multiple keys 38, or groups of keys 38 of the keyboard 22. For example, one LED may backlight arrow keys or a number pad.

The electronic device 10 also may take the form of a desktop computer system 40 as generally illustrated in FIG. 3. In certain embodiments, the electronic device 10 in the form of the desktop computer system 40 may be a model of an iMac®, Mac® mini, or Mac Pro® available from Apple Inc. of Cupertino, Calif. The desktop computer system 40 may include a housing 42, a display 18, and input structures 20, among other things. The input structures 22, such as a wireless keyboard 22 and/or mouse 44, may be used to interact with the desktop computer system 40. The array of keys 38 on the keyboard 22 responds to physical input to receive user input. The keyboard 22 may be a contact-type keyboard or a capacitance-type keyboard. Via the input structures 20 such as the keyboard 22, a user may start, control, or operate a GUI or applications running on the desktop computer system 40. The array of keys 38 on the keyboard 22 is backlit with a backlight 30 below the keys 38. The array of lights (e.g., LEDs) of the backlight 30 may be arranged with the keys 38 in a 1:1 ratio to enable each key 38 to be backlit differently. As discussed with the keyboard 22 of the laptop computer 32, some keys 38 may have multiple LEDs, one or fewer LEDs, or some LEDs may backlight multiple keys 38.

Regardless of whether the electronic device 10 takes the form of the computer 32 of FIG. 2, the desktop computer system 40 of FIG. 3, or some other form, the keyboard 22 has an array of keys 38 with an array of lights (e.g., LEDs) in a backlight 30 that are arranged to backlight the array of keys 38. The backlight 30 enables a desired pattern or set of keys 38 to be backlit without backlighting the entire array of keys 38. For example, the backlight 30 may backlight the entire array of keys 38 uniformly. Alternatively, the backlight 30 may backlight a first set of keys 38 (e.g., letters) at a different brightness level than a second set of keys 38 (e.g., numbers). The array of lights of the backlight 30 is connected to a controller of the keyboard 22 by a matrix of driving row lines and driving column lines. The array of keys 38 is connected to the controller, and the keys 38 are arranged in a matrix of scanning row lines and scanning column lines. The row lines (e.g., driving row lines, scanning row lines) of the arrays are electrically connected to the controller by row pins, and the column lines (e.g., driving column lines, scanning column lines) of the arrays are electrically connected to the controller by column pins. Presently contemplated embodiments of the backlight 30 and the array of keys 38 share row pins and/or column pins in a shared matrix electrically connected to a common controller of the keyboard 22. That is, the array of lights of the backlight 30 may be on the same row lines and/or column lines of the array of keys 38. The shared matrix reduces the number of pins electrically connecting the backlight 30 and the array of keys 38 to the keyboard controller compared to a separate backlight and array of keys with two sets of row lines and two sets of column lines.

The array of keys 38 and the array of lights of the backlight 30 may be arranged in various patterns with different quantities of keys. In certain embodiments, the keyboard 22 may be a model of an Apple Keyboard with Numeric Keypad or Apple Wireless Keyboard available from Apple Inc of Cupertino, Calif. By way of example, the keyboard 22 of FIG. 3 shows 78 keys arranged in approximately six rows and approximately fourteen columns. However, row lines and column lines connecting the keys 38 and backlight 30 may be arranged differently. For example, some embodiments may connect some keys 38 (e.g., space bar, arrow keys) in different arrangements so that each of the row lines does not connect with the same quantity of column lines as other row lines. Some embodiments of the keyboard 22 may include, but are not limited to, an accounting keypad with approximately 20 keys arranged in approximately four rows and approximately five columns. Presently contemplated embodiments are not limited to keyboards 22 having any particular quantity of keys 38, rows, or columns. Some embodiments disclosed below have matrices with six rows and seven columns, and some embodiments have matrices with three rows and three columns. Presently contemplated embodiments of the keyboard 22 may have a shared matrix of keys and light sources with other quantities of keys, rows, and/or columns.

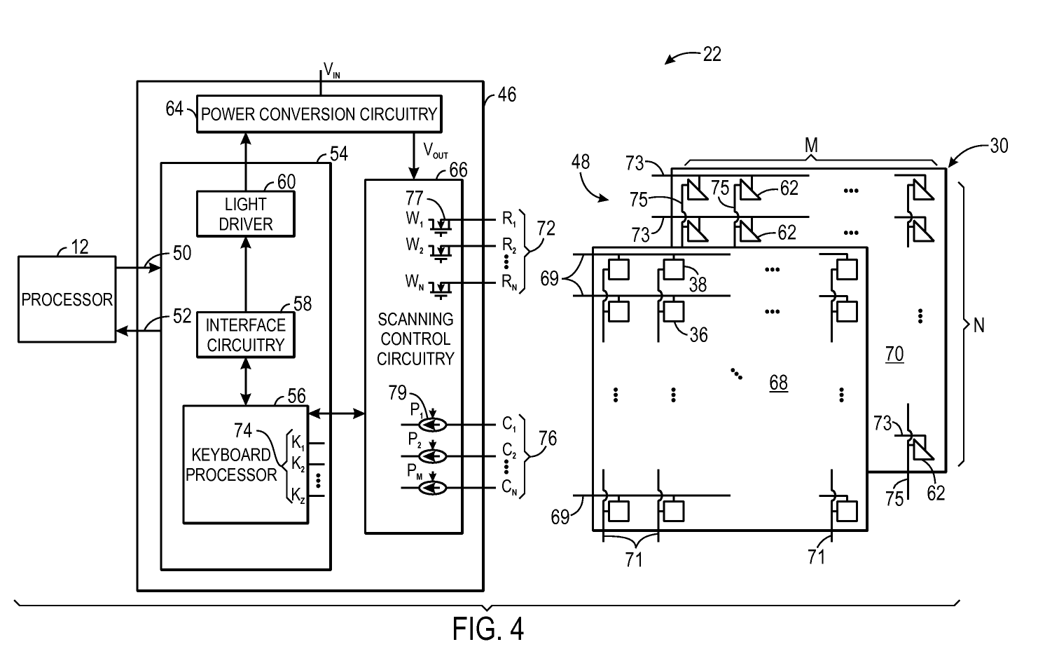

FIG. 4 illustrates a schematic of a keyboard controller 46 and shared matrix 48 of an input device 20 of a presently contemplated embodiment. The keyboard controller 46 receives input signals 50 from the processor 12 and transmits output signals 52 to the processor 12. The input signals 50 may include, but are not limited to a clock signal, a keyboard enable signal, or key backlight input used to determine which keys 38 to backlight and a backlight brightness setting. The output signals 52 may include, but are not limited to data input from the keys 38 or settings of the keyboard 22. Control logic 54 communicates with the processor 12 through the input signals 50 and output signals 52. A keyboard processor 56 of the control logic 54 determines when keys 38 of the keyboard 22 are pressed, processes data input from key presses to output signals 52, and controls the scanning process to detect key presses and drive the backlight 30. Interface circuitry 58 of the control logic 54 communicates the input signals 50 and output signals 52 between the processor 12 and the keyboard processor 56. In some embodiments, the interface circuitry 58 is an inter-integrated circuit (I²C) interface connecting the keyboard 22 to the electronic device 10. The interface circuitry 58 provides key backlight input, such as driving instructions, to a light driver 60 for controlling the brightness level of each light 62 (e.g., LED) of the array of lights of the backlight 30.

Power conversion circuitry 64 receives a voltage input V_{IN} from a power source and supplies a suitable voltage output V_{OUT} to drive LEDs 58 of the backlight 30. The power conversion circuitry 64 may be a DC-to-DC converter, such as an adaptive buck converter, to regulate the V_{OUT} supplied to the LEDs 62 through scanning control circuitry 66 of the control logic 54. The scanning control circuitry 66 is connected to the shared matrix 48 with row pins 72 (R₁, R₂, . . . R_{N}) and column pins 76 (C₁, C₂, . . . C_{M}) where N is the quantity of rows and M is the quantity of columns of the arrays of the shared matrix 48. A first array 68 of N×M keys 38 shares N row pins and/or M column pins connected to the scanning control circuitry 66 with a second array 70 of N×M LEDs 62. The row pins 72 are electrically connected to row lines to supply the output voltage to each row of keys 38 and LEDs 62. The scanning control circuitry 66 may supply the output voltage to each row pin 72 separately during a row interval for the respective row pin 72. The column pins 76 are electrically connected to column lines to drive LEDs 62 during the respective row interval based at least in part on key backlight input. Presently contemplated embodiments of the shared matrix 48 are not limited to the embodiments discussed herein. Arrays of keys 38 and LEDs 62 may share various quantities of row pins and/or column pins. In some embodiments, the first array of keys 38 may share only a portion of its row pins 72 or column pins 76 with the second array of LEDs 62.

The keys 38 of the first array 68 are arranged along a first set of row lines 69 and a first set of column lines 71. The LEDs 62 of the second array 70 are arranged along a second set of row lines 73 and a second set of column lines 75. In some embodiments, the first array 68 shares the first set of row lines 69 with the second array 70 so that one set of shared row lines are electrically connected to the set of row pins 72, rather than each array connecting via separate sets of row pins 72. In some embodiments, the first array 68 shares the first set of column lines 71 with the second array 70 so that one set of shared column lines are electrically connected to the set of column pins 76, rather than each array connecting via separate sets of column pins 76. Additionally, in some embodiments the first array 68 and the second array 70 of the shared matrix 48 are electrically connected to the set of row pins 72 and to the set of column pins 76 via sharing the first set of row lines 69 and the first set of column lines 71. Shared row lines and/or shared column lines enable the keyboard controller 46 to address both the first array 68 and the second array 70 with the same set of row pins 72 and/or the same set of column pins. For example, shared row lines and shared column lines enable the keyboard controller to drive individual LEDs and scan for key presses during a row interval while utilizing one set of row pins 72 and one set of column pins 76.

The keyboard processor 56 may detect when a key 38 is pressed by monitoring signals on key sensing pins 74 (K₁, K₂, . . . K_{Z}) where Z is the quantity of key sensing pins 74. In some embodiments, the key sensing pins 74 may detect key presses by monitoring signals from row lines via comparators so that Z is equal to the quantity of rows N. In some embodiments, the key sensing pins 74 may detect key presses by monitoring signals from column lines via comparators so that Z is equal to the quantity of columns M. The keyboard processor 56 determines which key is pressed utilizing signals from the first set of row lines 69 and the first set of column lines 71, both of which may be shared with the second array 70 of LEDs 62. For example, pressing a key on the fifth row and third column (e.g. R₅, C₃) may change a signal on a third column line that is sensed during the row interval when a fifth row line is charged with the output voltage. In some embodiments, the key sensing pins 74 are connected to the first set of column lines 71 and the column pins 76 are connected to the second set of column lines 75. In these embodiments, there are two sets of pin connections external to the keyboard controller 46 that are connected to the columns of the shared matrix 48. In some embodiments, the column pins 76 are connected to the shared set of column lines and the key sensing pins 74 are connected to comparators on the column pins 76 that are internal to the keyboard controller 46. In these embodiments, there is one set of pin connections external to the keyboard controller 46 that is connected to the columns of the shared matrix 48.

The scanning control circuitry 66 may address all of the keys 38 and all of the LEDs 62 during a scanning period. The control logic 54 sets the duration of the scanning period based at least in part on a clock signal received from the processor 12 or clock generator internal to the control logic 54. The frequency of the clock signal may be greater than approximately 500 MHz, 800 MHz, or 1 GHz. The control logic 54 may control the quantity of scanning periods per second (e.g., scanning frequency) based on a user input or instructions programmed in memory. The control logic 54 may scan the first array of keys 38 and the second array of LEDs 62 at scanning frequencies between approximately 200 Hz to 40 kHz, approximately 5000 Hz to 30 kHz, approximately 15 kHz to 25 kHz, or greater than approximately 20 kHz. Scanning frequencies greater than 20 kHz may reduce noise audible to an operator. The scanning period for all the keys 38 and the LEDS 62 may be between approximately 5 ms to 25 μs. In some embodiments, the control logic 54 divides the scanning period into row intervals with durations between approximately 10 ms to 1 μs. The scanning control circuitry 66 addresses the keys 38 and LEDs 62 of one row (e.g., row pin) per row interval. The user may adjust the scanning frequency and duration of each row interval through user input.

The scanning control circuitry 66 addresses one row of the shared matrix 48 per row interval using row transistors 77 (W₁, W₂ . . . W_{N}) coupled to each row pin 72. The power conversion circuitry 64 supplies the output voltage V_{OUT} to each row pin 72 individually by switching row transistors 77 on the respective row pins 72 so that one row transistor 77 is closed at a time. For example, the scanning control circuitry closes row transistor W₁ and opens row transistors W₂-W_{N} to supply V_{OUT} along row pin R₁ for a row interval. After the row interval elapses, the scanning control circuitry may open row transistor W₁ and close row transistor W₂ to address row pin R₂. Accordingly, the control logic 54 may sequentially close row transistors W₁-W_{N} to sequentially supply V_{OUT} to each row pin R₁-R_{N} and connected row lines (e.g., shared row lines). The scanning control circuitry 66 controls the LEDs 62 on each row line during the respective row interval. Current sinks 79 (P₁, P₂, . . . P_{M}) of the scanning control circuitry 66 are coupled to each column pin C₁-C_{M} to drive the LEDs 62. Turning on a current sink 79 on a column pin during a row interval drives the LED 62 on the corresponding row line and column lines. For example, turning on the current sink P₁ when the row transistor W₂ supplies the output voltage to row pin R₂ drives the LED 62 on the second row and first column of the shared matrix 48. Accordingly, the scanning control circuitry 66 may turn on the current sink 79 P₁ during each row interval of the scanning period to drive the first column of LEDs 62 to backlight the first column of keys 38 for the duration of the scanning period.

As the scanning control circuitry 66 addresses one row of the shared matrix 48 per row interval, one row of LEDs 62 may be driven to backlight one row of keys 38 during the row interval, while the remaining rows of LEDs 62 are not driven (e.g., turned-off) during the row interval. However, while the LEDs 62 of a row of the shared matrix 48 may not be driven for the whole scanning period, the scanning frequency may be of sufficient magnitude (e.g., 20 kHz or more) that the human eye may not perceive the LEDs 62 turning off. The LEDs 62 on each row may be driven for a fraction of the scanning period, similar to pulse width modulation control of the LEDs 62. For example, a keyboard 22 with a shared matrix 48 having five rows of keys 38 with corresponding LEDs 62 may drive each row of LEDs 62 for approximately 20% of the duration of the scanning period, or with a 20% duty cycle over the scanning period. The keyboard controller 46 may adjust the perceived brightness of each LED 62 by adjusting the duration that the LED 62 is driven during each row interval. In some embodiments, the scanning control circuitry 66 divides the row interval into a driving interval to drive the LEDs 62 and a sensing interval to detect key presses. Adjusting the duration of the driving interval as a ratio of the row interval affects the perceived brightness of the LED 62 by adjusting the duty cycle.

The keyboard controller 46 drives the LEDs 62 of the shared matrix 48 based at least in part on key backlight input from the processor 50 or keyboard processor 56. The keyboard controller 46 may turn on the LEDs 62 in any desired pattern during the scanning period based on the key backlight input. In some embodiments, the key backlight input directs each of the keys 38 to be backlit by the LEDs 62. The keyboard controller 46 may differentially control the LEDs 62 to backlight individual keys 38 of the keyboard 22. In some embodiments, the keyboard controller 46 may backlight keys 38 in response to changes in ambient light or in response to a user activated control. In some embodiments, the keyboard controller 46 may differentially backlight keys 38 based on a current user activity (e.g., software application) to support spell checking, gaming controls, or suggest keys 38 to be pressed. Accordingly, a current user activity, the ambient environment of the keyboard 22, or a user control on the keyboard 22 or electronic device 10 may adjust the key backlight input to control how the keys 38 are backlit. For example, the LEDs 62 may backlight keys 38 that are mapped to specific commands related to the current user activity or to a predicted user input. In some embodiments, the keyboard controller 46 determines which LEDs 62 to drive (e.g., turn on) based on the input signals 50 and/or which keys 38 are pressed.

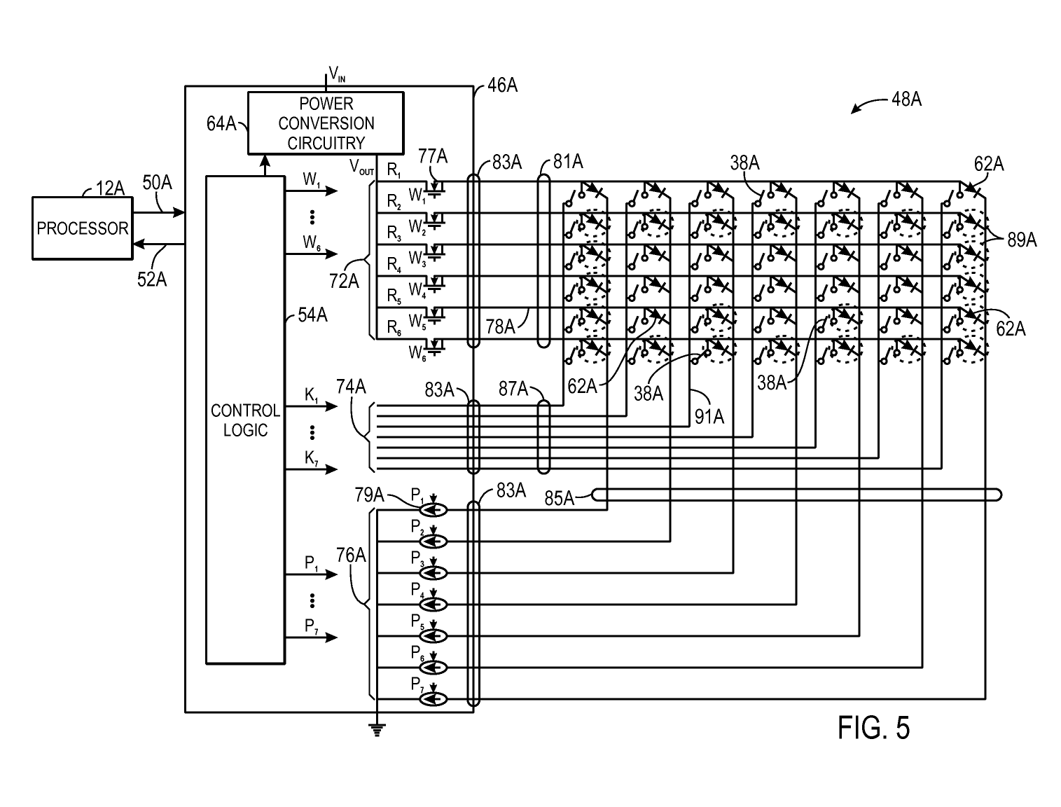

The shared matrix 48 of the first array of keys 38 and the second array of LEDs 62 may share a set of row pins 72 and/or a set of column pins 76 that connect the shared matrix 48 to the keyboard controller 46. The first embodiment shown in FIG. 5 illustrates a shared matrix 48A with a set of shared row lines 81A connected to each pair of keys 38A and the LEDs 62A. The shared matrix 48A is electrically connected to the keyboard controller 46A by pin connections 83A at the row pins 72A, the column pins 76A, and the key sensing pins 74A. The pin connections 83A connect the row pins 72A to the set of shared row lines 81A, the column pins 76A to a set of light column lines 85A, and the key sensing pins 74A to a set of key column lines 87A. The set of shared row lines 81A connect to respective rows of the pairs of keys 38A and LEDs 62A. The set of light column lines 85A connect to columns of the LEDs 62A, and the set of key column lines 87A connect to columns of the keys 38A. Accordingly, the shared matrix 48A shows 20 pin connections 83A between the keyboard controller 46A and the shared matrix 48A. The shared row lines 81A enable the keyboard controller 46A to address the LEDs 62A and keys 38A of the shared matrix 48A with fewer pin connections 83A than if the array of keys 38A and the array of LEDs 62 were addressed via separate sets of row lines and column lines. While the first embodiment of FIG. 5 illustrates a shared matrix 48A as an example with six rows and seven columns, presently contemplated embodiments are not limited to any particular quantities of rows or columns.

The control logic 54A of the keyboard controller 46A controls the row transistors 77A to supply the output voltage to the shared row lines 81A via the row pins 72A during row intervals of the scanning period. During each row interval, the control logic 54A controls the current sinks 79A to drive LEDs 62 based on the key backlight input for the row interval. Turning on a current sink 79A draws current across the LED 62 between a shared row line 81A and a light column line 85A. Each pair of keys 38A and LEDs 62A may be identified by the respective row line and column line of the shared matrix 48A. A dashed circle 89A indicates the LEDs 62A that are driven to emit light during the scanning period. For example, the LEDs 62A at R₂C₁₋₇, R₃C₁, R₃C₇, R₄C₁, R₄C₇, R₅C₁, R₅C₃, R₅C₅, R₅C₇, and R₆C₁₋₇ are driven during the scanning period. The control logic 54 controls the respective current sinks P₁-P₇ to turn on during the respective row intervals to drive the respective LEDs 62A.

The control logic 54A detects key presses via monitoring signals on the key column lines 87A. Pressing a key 38 closes a switch between a shared row line 81A and a key column line 87A, changing the voltage of the key column line 87A. The key column lines 87A are connected via the pin connections 83A to the key sensing pins 74A. Accordingly, closing a switch on a row line during the corresponding row interval transmits a signal (e.g., V_{OUT}) along the key sensing pins 74A. In the shared matrix 48A, the key 38A at R₅, C₃ is pressed during the scanning period, closing the switch between the fifth shared row line 78A (R₅) and the third key column line 91A (C₃) during the row interval on the fifth row line 78A. This closed switch changes the voltage on key sensing pin K₃ without substantially affecting the signal on the light column lines 85A.

The first embodiment of FIG. 5 illustrates shared row lines 81A of the shared matrix 48A that reduces the quantity of pin connections 83A between the shared matrix 48A and the keyboard controller 46A. This enables the keyboard controller 46A to address the keys 38A to detect key presses separately from addressing the LEDs 62 to backlight a desired pattern of keys 38A with a reduced quantity of pin connections 83A and row lines. In the first embodiment, the keyboard controller 46A may drive the LEDs 62A independent of detecting key presses. For example, pressing a key 38A during a scanning period may have substantially no effect on whether the corresponding LED 62A may be driven to backlight the key 38A during the scanning period.

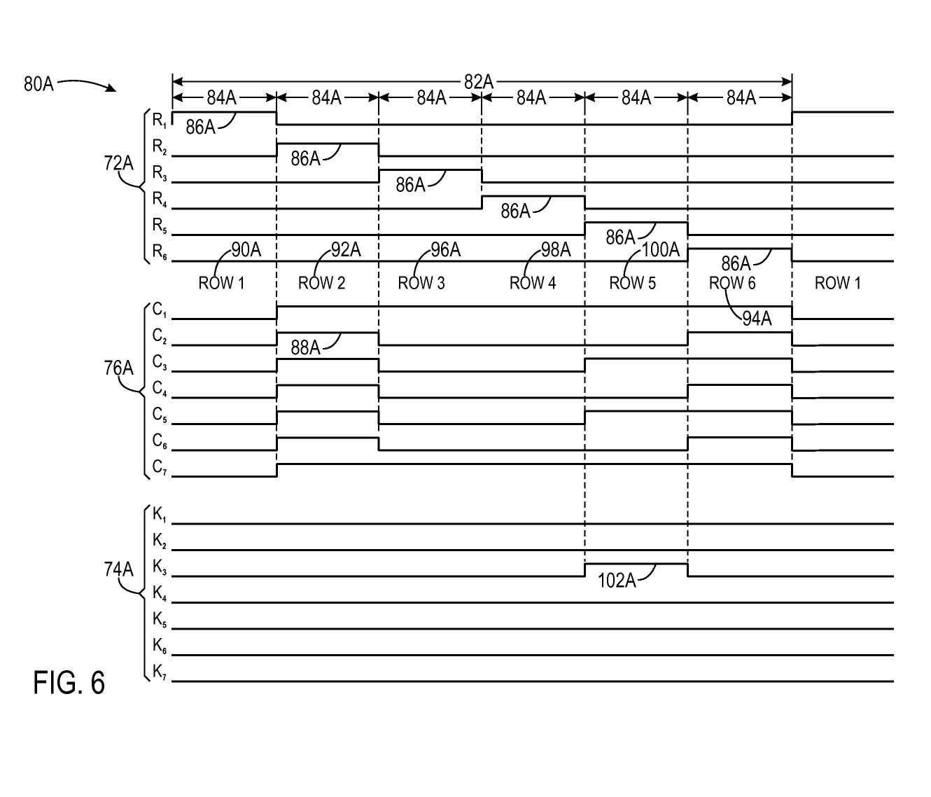

FIG. 6 illustrates a timing diagram 80A of the scanning period shown in the shared matrix 48A of FIG. 5. As discussed above, the control logic 54A divides the scanning period 82A into row intervals 84A by controlling the row transistors 77A W₁-W₆. In some embodiments, the duration of the row intervals 84A may be substantially equal. The row intervals 84A for each respective row pin R₁-R₆ are shown as sequential high row signals 86A. A high row signal 86A on a row pin 72A is supplied to the pairs of keys 38A and LEDs 62A arranged on the shared row line 81A. The control logic 54A controls the respective current sinks 79A to be turned on during each row interval 84A to drive the LEDs 62A. The timing diagram 80 depicts when a current sink 79A is turned on with a high column signal 88 on the respective column pin 76A during the appropriate row intervals 84. A high column signal 88A on a column pin 76A drives the LED 62A on the respective light column line 85A. For example, none of column pins 76A during the first row interval 90A have high column signals 88A in FIG. 6, which corresponds with LEDs 62A on R₁ of FIG. 5 that are turned off. All of the current sinks 79A are controlled to turn on with high column signals 88A on the respective column pins C₁-C₇ during a second row interval 92A on R₂ and a sixth row interval 94A on R₆. The high column signals 88A on column pins C₁-C₇ during high row signals 86A on R₂ and R₆ of FIG. 6 correspond to the turned-on LEDs 62A on R₂ and R₆ of FIG. 5. For a third row interval 96A and a fourth row interval 98A, the current sinks P₁ and P₇ are controlled to have high column signals 88A on column pins C₁ and C₇ of FIG. 6 to correspond to the turned-on LEDs 62A on row pins R₃ and R₄ of FIG. 5. For a fifth row interval 100A, the current sinks P₁, P₃, P₅, and P₇ are controlled to have high column signals 88A on column pins C₁, C₃, C₅, and C₇ of FIG. 6 to correspond to the turned-on LEDs 62A on row pin R₅ of FIG. 5.

The timing diagram 80A illustrates high key signals 102A on the key sensing pins 74A to identify when a key 38A is pressed. In the first embodiment of FIG. 5 only the key 38A at (R₅K₃) (e.g., fifth row line 78A and third key column line 91A) is pressed during the scanning period 82A. Accordingly, pressing the key at R₅K₃ causes a high key signal 102A on the third key column line 91A, which passes the high key signal 102A to the third key sensing pin K₃ through a pin connection 83A of the keyboard controller 46A during the fifth row interval 100A. This high signal 102 in the fifth row interval 100A indicates to the control logic 54A that the corresponding key was pressed during the scanning period. The control logic 54A may transmit an output signal 50A to the processor 12A based on the high key signals 102A during each scanning period. The control logic 54A may detect when multiple keys 38A on the same shared row line 81A are pressed during a row interval 84A via the key column lines 85A and key sensing pins K₁-K₇.

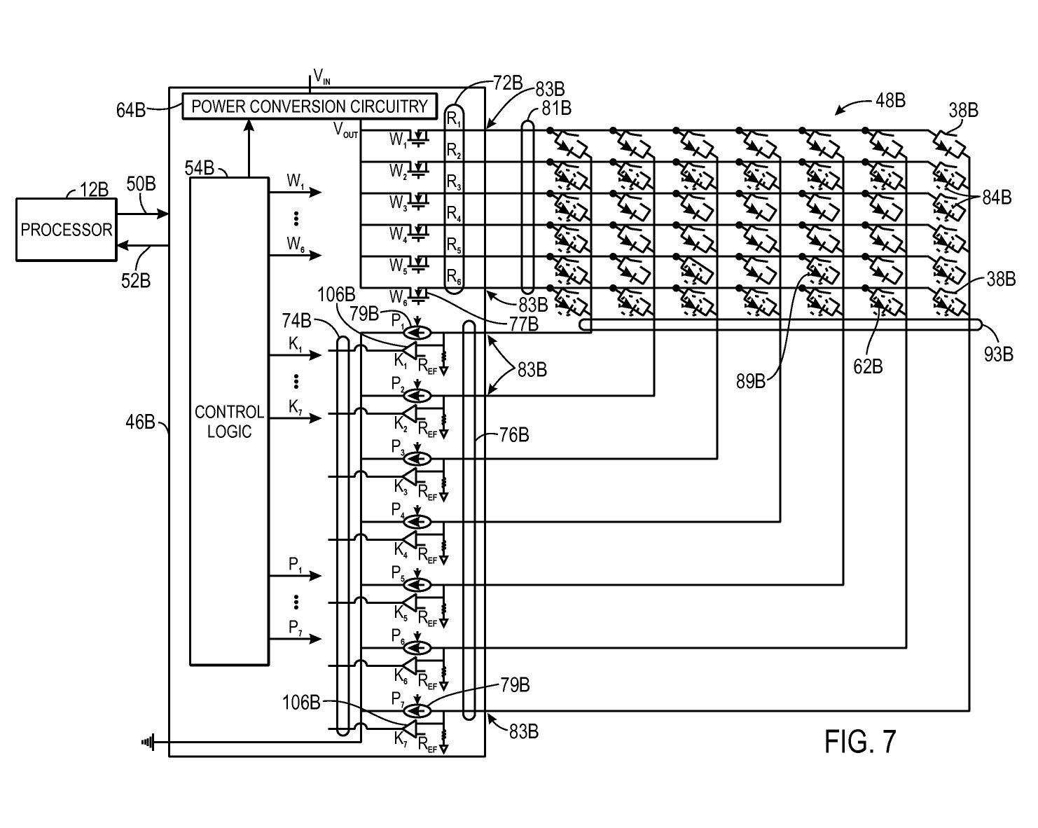

The first embodiment discloses utilizing shared row lines 81A between a first array of keys 38A and a second array of LEDs 62A to reduce the quantity of pin connections 83A between a shared matrix 48A and a keyboard controller 46A. Further reduction of the quantity of pin connections between the shared matrix 48 and keyboard controller 46 frees additional pins of the keyboard controller 46 that may be eliminated or used for other purposes. A second embodiment shown in FIG. 7 illustrates a shared matrix 48B utilizing shared row lines 81B and shared column lines 93B between the first array of keys 38B and the second array of LEDs 62B to reduce the quantity of pin connections 83B between the shared matrix 48B and the keyboard controller 46B. In contrast to the first embodiment, the second embodiment has one set of shared row lines 81B and one set of shared column lines 93B. Accordingly, the shared matrix 48B shows 13 pin connections 83B between the keyboard controller 46B and the shared matrix 48B. The shared row lines 81B and the shared column lines 93B enable the keyboard controller 46B to address the LEDs 62B and the keys 38B of the shared matrix 48B with fewer pin connections 83B than the first embodiment. Furthermore, the second embodiment is an example of the shared matrix 48B, and other embodiments of the shared matrix 48B are not intended to be limited to six rows and seven columns.

The control logic 54B controls the row transistors 77B similar to the row transistors 77A of the first embodiment to supply voltage to the shared row lines 81B during row intervals of the scanning period. The current sinks 79B are connected to shared column lines 93B, but otherwise are controlled by the control logic 54B similarly to the first embodiment to drive the LEDs 62B on the shared column lines 93B. Each pair of keys 38B and LEDs 62B is arranged in parallel between a shared row line 81B and a shared column line 93B. The LEDs 62B are driven by a voltage difference between the shared row line 81B and the shared column line 93B. Pressing a key 38B of a pair closes a key switch that short circuits the corresponding LED 62B, reducing the voltage difference across the LED 62 while the key 38B is pressed. Accordingly, the LEDs 62B of the second embodiment may not backlight a key 38B while it is pressed. Once the key 38B is released and the key switch opens, the control logic 54B may control the current sinks 79B to drive the respective parallel LED 62B to backlight the key 38B.

The keyboard controller 46B utilizes comparators 106B on the column pins 76B connected to the shared column lines 93B to sense key presses. The comparators 106B detect when a key 38B is pressed by comparing the voltage on the column pin 76B from the corresponding shared column line 93B with a reference voltage. For example, pressing a key 38B short circuits the parallel LED 62 and may cause the voltage on the corresponding column pin 76B to be approximately equal to the output voltage. The comparators 106B of the keyboard controller 46B may transmit signals to the control logic 54B to indicate when a key 38B is pressed. The comparators 106B may transmit the signals via key sensing pins 74B (K₁-K₇) that are internal to the keyboard controller 46B. The key sensing pins 74B of FIG. 7 are not connected to the keys 38B or LEDs 62B of the shared matrix 48B by any separate pin connections 83B. That is, the key sensing pins 74B do not have external pin connections 83B with the shared matrix 48B. This reduces the quantity of pin connections 83B electrically connecting the shared matrix 48B to the keyboard controller 46B. Additionally, this reduces the quantity of lines (e.g., row and column lines) of the shared matrix 48B.

In FIG. 7, dashed circles 89B indicate the LEDs 62B that the control logic 54B directs the current sinks 79B to turn on based on key backlight input. The key backlight input of the second embodiment directs the control logic 54B to drive the LEDs 62B in the same pattern as in the first embodiment of FIG. 5. That is, the key backlight input directs the control logic 54B to drive the LEDs at R₂C₁₋₇, R₃C₁, R₃C₇, R₄C₁, R₄C₇, R₅C₁, R₅C₃, R₅C₅, R₅C₇, and R₆C₁₋₇ during the scanning period. However, the pressed key at R₅C₃ short circuits the parallel LED 62B so that the voltage across the LED 62B is insufficient to drive the LED 62B at R₅C₃ backlight the pressed key 38B.

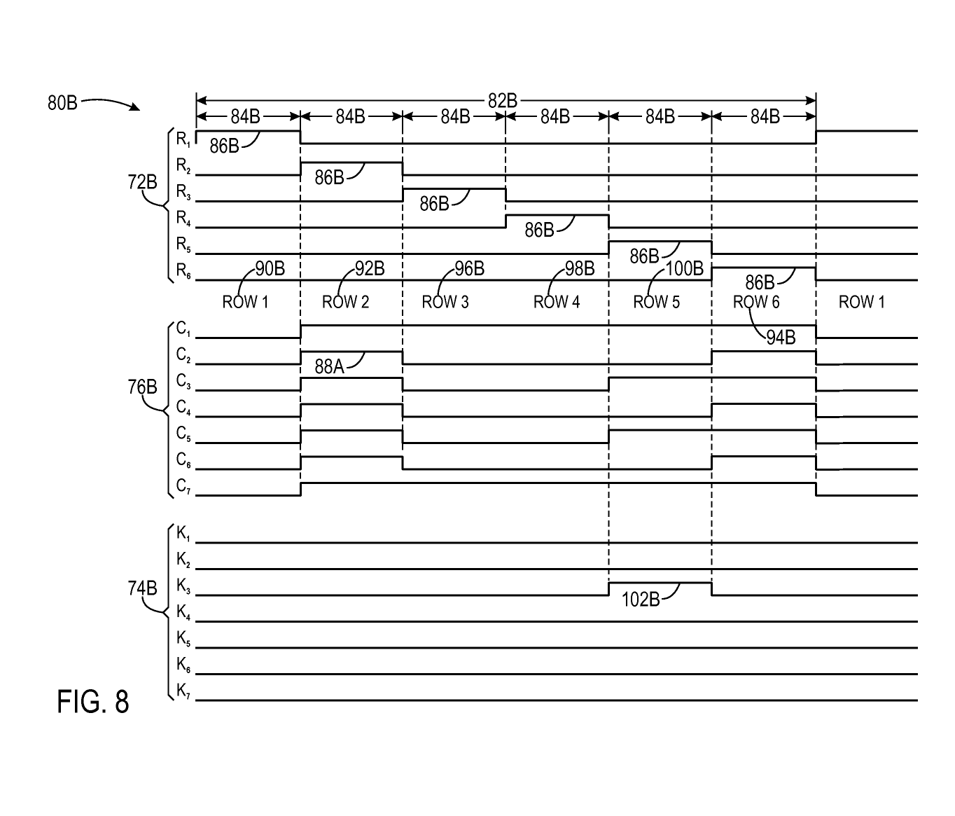

The timing diagram 80B of FIG. 8 for the second embodiment shown in FIG. 7 may be similar to the timing diagram 80A of FIG. 6 for the first embodiment shown in FIG. 5. The control logic 54B divides the scanning period 82B into row intervals 84B by controlling the row transistors 77B W₁-W₆. The row intervals 84B for each respective row pin 72B R₁-R₆ are shown as sequential high row signals 86B. A high row signal 84B on a row pin 72B is supplied to the pairs of keys 38B and LEDs 62B arranged on the connected shared row line 81B. The control logic 54B controls the respective current sinks 79B to be turned on during each row interval 84B to drive the LEDs 62B. The timing diagram 80B depicts when a current sink 79B is turned on with a high column signal 88B on the respective shared column pin 93B during the appropriate row intervals 84B. That is, the high column signals 88B correspond to the backlight pattern of LEDs 62B shown in FIG. 7 by the dashed circles. However, the pressed key at R₅C₃ of FIG. 7 short circuits the parallel LED 62B so that the high signal 88B on the column pin C₃ during the fifth row interval 100B does not drive the corresponding LED 62B. Rather, the pressed key at R₅C₃ causes the comparator 106 on column pin C₃ to transmit a high signal 102B on the key sensing pin K₃ during the fifth row interval 100B.

The second embodiment reduces the quantity of pin connections 83B between the keyboard controller 46B and the shared matrix 48B compared to the first embodiment. The shared row lines 81B and the shared column lines 93B enable the array of LEDs 62B to be addressed using the existing row lines and column lines used to address the array of keys 38B. Additionally, turning off an LED 62B by short circuiting the LED 62B when a key 38B is pressed provides an indication to the user of when the control logic 54 detects a key press.

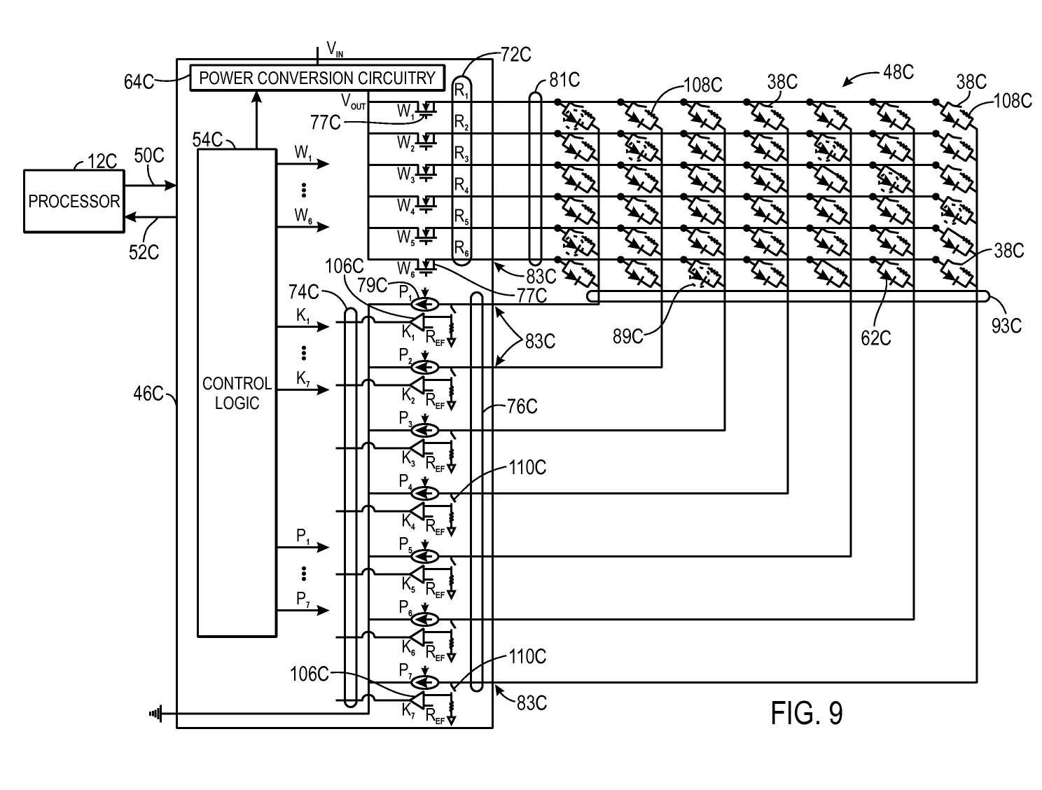

Some embodiments may enable a key 38C to remain backlit when the key 38C is pressed. A third embodiment shown in FIG. 9 illustrates a shared matrix 48C utilizing shared row lines 81C and shared column lines 93C between the keyboard controller 46C and the shared matrix 48C. While the shared matrix 48C may have the same quantity of pin connections 83C as a similarly sized embodiment of the shared matrix 48B disclosed above in FIG. 7, the control logic 54C and the keys 38C enable the keyboard controller 46C to backlight keys 38C regardless of whether the key 38C is pressed. Similar to the second embodiment, pairs of keys 38C and LEDs 62C are connected in parallel between one set of shared row lines 81C and one set of shared column lines 93C.

Similar to the second embodiment of FIG. 7, the pairs of keys 38C and LEDs 62C of the third embodiment of the shared matrix 48C are connected in parallel between the shared row lines 81C and the shared column lines 93C. A resistor 108C is in series with the key switch of key 38C and parallel to the LED 62C of each pair in the shared matrix 48C. The resistance of the resistor 108C may be substantially greater than the resistance of the parallel LED 62C so that most of the current flows through the LED 62C rather than the resistor 108C when the key 38C is pressed. For example, the resistance of the resistor 108C may be approximately 10 kΩ or more. Thus, the resistor 108C of each pair of keys 38C and LEDs 62C enables the LEDs 62C to backlight the respective key 38C regardless of whether the key 38C is pressed.

The control logic 54C controls the row transistors 77C similar to the row transistors 77B of the second embodiment to supply the output voltage to the shared row lines 81C during row intervals of the scanning period. The shared column pins 76C are connected to the current sinks 79C and key sensing switches 110C (KS₁-KS₇) of the keyboard controller 46C. During each row interval, the control logic 54C controls the current sinks 79C and key sensing switches 110C to divide the row interval into a driving interval and a sensing interval. The key sensing switches 110C are open and the current sinks 79C may be turned on during the driving interval to drive the LEDs 62C on a respective shared column line 93C. During the sensing interval, the current sinks 79C may be turned off and the key sensing switches 110C are closed to connect the comparators 106 to the shared column lines 93C to detect when a key 38C is pressed (e.g., when a key switch is closed).

The control logic 54C of the third embodiment may operate in two modes during each row interval of the scanning period to drive the LEDs 62C separately from detecting key presses. To drive the LEDs 62C during a row interval, the control logic 54C opens the key sensing switches 110C and turns on the current sinks 79C corresponding the LEDs 62C that are to be driven based on the key backlight input. This portion of the row interval when the LEDs 62C may be driven is herein referred to as the driving interval. The current through the LED 62C may be sufficient to drive the LED 62C even when the key 38C is pressed during the driving interval because of the resistor 108C in parallel with the LED 62C. Accordingly, the LED 62C may be driven during driving intervals of subsequent scanning periods while the key 38C is pressed. The control logic 54C may adjust the duration of the driving interval through controlling the current sinks 79C and the key sensing switches 110C. Adjusting the duration of the driving interval may adjust the perceived brightness of the LED 62C by adjusting the duty cycle. For example, an embodiment with five rows of LEDs 62C driven during five row intervals (e.g., each approximately 20% of scanning period), the control logic 54 may control each driving interval to be approximately 50% of the duration of the respective row interval to backlight the key 38C with approximately 10% duty cycle (e.g., 50% driving interval*20% scanning period=10% duty cycle).

The control logic 54 may close the key sensing switches 110C to start the sensing interval of the row interval. The duration of the sensing interval may be approximately the remainder of the row interval after the driving interval has elapsed. The control logic 54C turns off the current sinks 79C to stop driving the LEDs 62C during the sensing interval. However, turning off the LEDs 62C during the sensing interval may be imperceptible to the user due to the scanning frequency. Closing the key sensing switches 110C connects the comparators 106C to the column pins 76C. The column pins 76C receive signals from the shared column lines 93C. The comparators 106C compare the voltage from the shared column lines 93C to reference voltages to determine whether a key 38C is pressed during the sensing interval. While pressing a key 38C may not substantially reduce the current through the parallel LED 62C to turn off the LED 62C during the driving interval, pressing the key 38C to close the key switch parallel to the LED 62C during the sensing interval affects the signal on the column line 93C so that the respective comparator 106C may detect the key press. The comparators 106C transmit signals via the key sensing pins 74C that are internal to the keyboard controller 46C. Like the second embodiment, the key sensing pins 74C of FIG. 9 are not connected to the keys 38C or the LEDs 62C of the shared matrix 48C by any separate pin connections 83C. This reduces the quantity of pin connections 83C electrically connecting the shared matrix 48C to the keyboard controller 46C.

Dashed circles 89C indicate the LEDs 62C that the control logic 54C directs the current sinks 79C to turn on during the driving intervals of the scanning period based on key backlight input. The key backlight input of the third embodiment directs the control logic 54C to drive the LEDs 62C at R₁C₁, R₂C₂, R₂C₅, R₃C₆, R₄C₇, R₅C₁, and R₆C₃. The control logic 54C may detect the pressed keys 38C (and respectively closed key switches) at R₃C₅, R₃C₆, R₅C₇, and R₆C₅ during the sensing intervals of the scanning period.

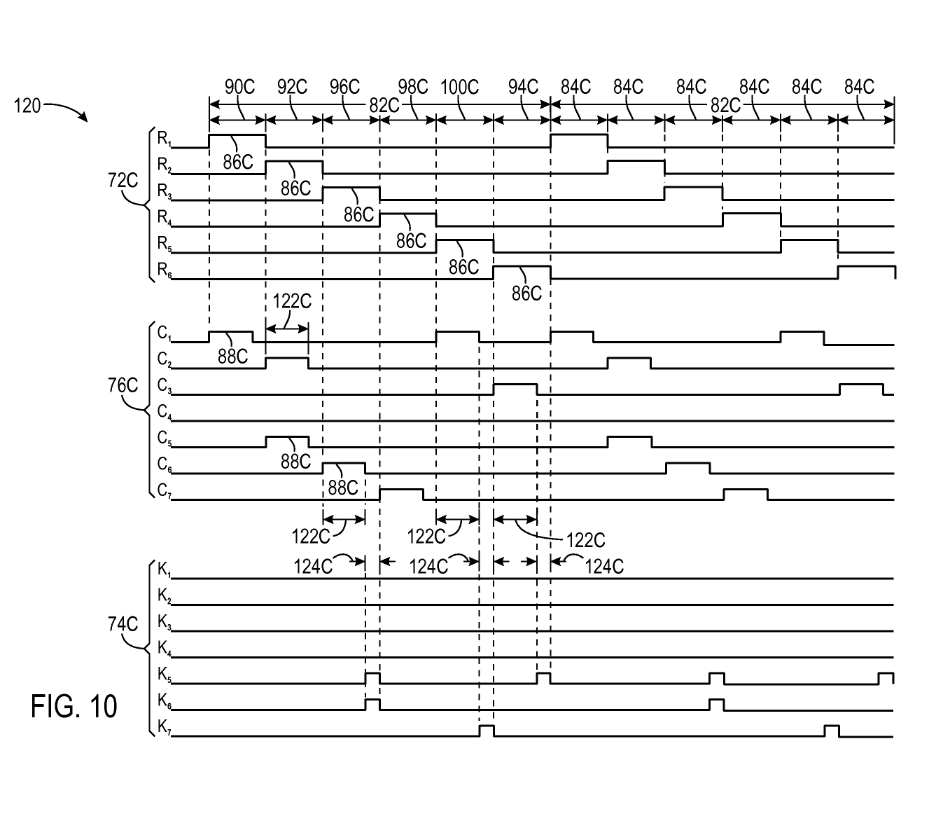

A timing diagram 120 of FIG. 10 illustrates two scanning periods 82C and the row scanning intervals 84C corresponding to the embodiment of FIG. 9. The control logic 54C divides each scanning period 82C into row intervals 84C, shown by high row signals 86C, to address the LEDs 62C and keys 38C on each shared row line 81C connected to a row pin 72C. The control logic 54C controls the current sinks 79C and the key sensing switches 110C to divide each row interval 84C into a driving interval 122C and a sensing interval 124C. In some embodiments, the durations of the driving interval 122C and the sensing interval 124C may vary between row intervals 84C and/or scanning periods 82C. During the driving interval 122C for each row pin 72C, the control logic 54C controls the current sinks 79C to drive the LEDs 62C on the respective shared row lines 81C based on key backlight input. High columns signals 88C on the column pins 76C indicate when an LED 62C is driven to backlight a key 38C. For example, the LEDs 62C at R₂C₂ and R₂C₅ are driven during the driving interval 122C of the second row interval 92C.

The control logic 54C turns off the current sinks 79C to turn off the LEDs 62C connected to row pin 72C after the driving interval 122C has elapsed. After each driving interval 122C, the control logic 54C switches the key sensing switches 110C to connect the comparators 106C to the respective column pins 76C to start the sensing interval 124C. The comparators 106C send a signal to the control logic 54C on key sensing pins 74C (K₁-K₇) to indicate when a key 38C is pressed during the sensing interval 124C for a row pin 72C. The timing diagram 120C illustrates key presses during the sensing intervals 124C with high key signals 102C. For example, the timing diagram 120 illustrates an embodiment in which the keys 38C at R₃C₅ and R₃C₆ are pressed during the third row interval 96C. In some embodiments, the sensing interval 124 may precede the driving interval 122.

The embodiments of the shared matrices 48A, 48B, and 48C discussed above share row pins 72 and/or column pins 76 to reduce the quantity of pin connections per key 38 of a backlit keyboard. Each key 38 may be individually backlit, and the keyboard controller 46 may individually control the brightness of the LED 62 for each key 38. Reducing the quantity of pin connections 83 between the shared matrix 48 and the keyboard controller 46 enables the shared matrix 48 and keyboard 22 to be thinner than a keyboard with separate arrays of keys and LEDs and corresponding separate row and column lines. Reducing the quantity of pin connections 83 to the shared matrix 48 may also reduce the complexity of the keys 38 and reduce manufacturing costs. Fewer pin connections 83 may reduce the overall power consumption of the shared matrix 48 due to lower resistance losses, heat, and so forth along the row lines and/or column lines. The integration of the first array of keys 38 with the second array of LEDs 62 enables the keyboard controller 46 to utilize fewer pins and/or enables the pins of the control logic 54 to be repurposed for other uses. For example, repurposed pins may be used to connect an additional input device including, but not limited to, a mouse, touch pad, or I/O device.

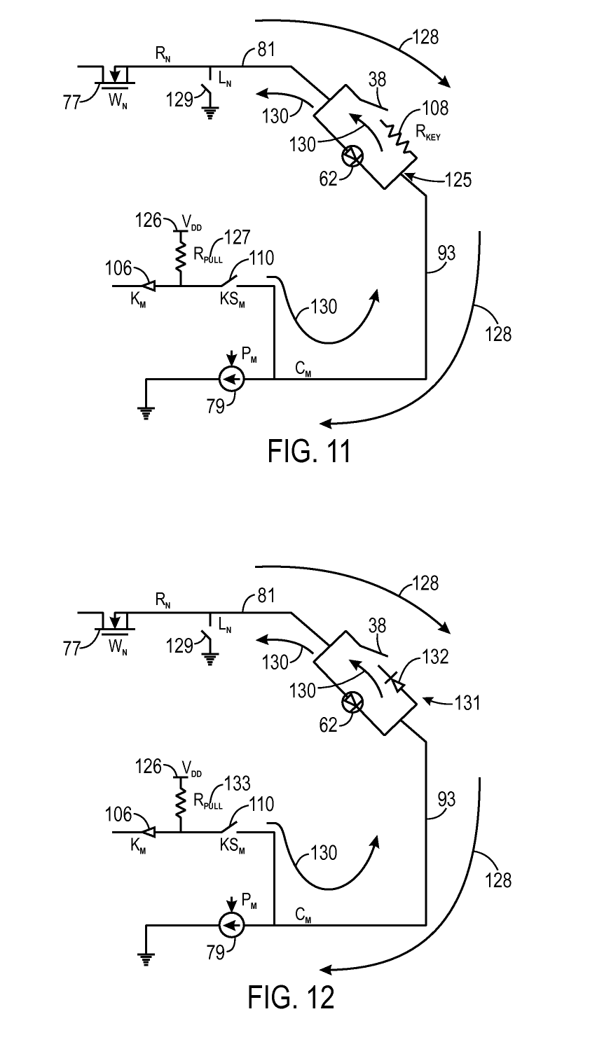

Some embodiments of the shared matrix 48 and keyboard 22 may improve power efficiency and/or reduce response time to detect a key press. FIG. 11 illustrates an embodiment of a lighted key 125 with the key switch 38 and LED 62 in parallel between a shared row line 81 (e.g., R_{N}) and a shared column line 93 (e.g., Cₘ). A supply voltage 126 (e.g., V_{DD}, V_{IN}, V_{OUT}) and a pull-up resistor 127 (e.g., Rₚᵤₗₗ) of the keyboard controller 46 is connected to the comparator 106 (e.g., Kₘ). In some embodiments, the pull-up resistor 127 may be substantially larger (e.g., approximately 2, 5, 10, or 100 times greater) than the resistor 108 (e.g., R_{key}) in parallel to the LED 62. R_{key} 108 may have a larger resistance than the LED 62 to enable most of the current to pass in a first direction 128 through the LED 62 if the lighted key 125 is pressed during the driving interval 122.

A line switch 129 (e.g., Lₙ) connects the key switch 38 and LED 62 to ground during the sensing interval 124, and is open during the driving interval 122. The key sensing switch 110 of the keyboard controller 46 closes during the sensing interval 124 to facilitate detecting a key press. During the driving interval 122, the current sink 79 directs the driving current through the LED 62 in the first direction 128. If the lighted key 125 is not pressed during the sensing interval 124, substantially no current flows in a second direction 130 through Rₚᵤₗₗ 127 and Lₙ 129 to ground due to the open key switch 38 and orientation of the LED 62. When the key switch 38 is open during the sensing interval 124, the voltage signal (V_{comp}) at the comparator 106 may be defined by Equation 1:

V_{comp}=V_{DD} Equation 1

If the lighted key 125 is pressed during the sensing interval 124, a current flows in the second direction 130 through Rₚᵤₗₗ 127 and Lₙ 129 to ground due to the closed key switch 38, dropping the voltage signal at the comparator 106. When the key switch 38 is closed during the sensing interval 124, V_{comp} at the comparator 106 is less than V_{DD} and may be defined by Equation 2:

V_{comp}=V_{DD}*R_{key}/(R_{key}+Rₚᵤₗₗ) Equation 2

The comparator 106 may sense the key press as a drop in V_{comp}. The pull-up resistor 127 enables V_{comp} at the comparator 106 to be approximately the supply voltage 126 unless the switch key sensing switch 110 is closed

FIG. 12 illustrates another embodiment of a lighted key 131 with the key switch 38 and LED 62 in parallel between a shared row line 81 (e.g., R_{N}) and a shared column line 93 (e.g., Cₘ). The lighted key 131 has a reverse-bias diode 131 in series with the key switch 38, and in parallel with the LED 62. The reverse-bias diode 131 may block substantially all driving current in the first direction 129 through the closed key switch 38 during the driving interval 122, thereby enabling substantially all the driving current to drive the LED 62. The reverse-bias diode 131 may enable the LED 62 to maintain a desired driving current during a key press, thereby reducing an effect of the key press on the brightness and/or color of the LED 62. In some embodiment, the lighted key 131 with the diode 132 may be connected to the comparator 106, a pull-up resistor 133 (e.g., Rₚᵤₗₗ), and V_{DD} 126 as discussed above with FIG. 11. The diode 132 may enable the resistance of the pull-up resistor 133 of FIG. 12 to be less than the resistance of the pull-up resistor 127 of FIG. 11. As may be appreciated, reducing the resistance of the pull-up resistor 133 decrease the response time for the comparator 106 to detect a key press.

If the lighted key 131 is pressed during the sensing interval 124, a current flows in the second direction 130 through Rₚᵤₗₗ 133 and Lₙ 129 to ground due to the closed key switch 38, dropping the voltage signal at the comparator 106. As may be appreciated, the diode 132 is reverse-biased against current flow in the first direction 128 (e.g., during the driving interval 122), and forward-biased with current flow in the second direction 130 (e.g., during the sensing interval 124). Thus, the diode 132 is biased in the opposite orientation of the LED 62. Accordingly, in the sensing interval 124 substantially all of the current flows in the second direction 130 through the diode 132, and substantially none of the current flows in the second direction 130 through the LED 62. In the driving interval 122, substantially all of the current flows in the first direction 128 through the LED 62, and substantially none of the current flows in the first direction 128 through the diode 132 even if the key switch 38 is closed. When the key switch 38 is closed during the sensing interval, V_{comp} at the comparator 106 is less than V_{DD} and may be defined by Equation 3:

V_{comp}=V_{diode} Equation 3

where V_{diode} is the voltage drop across the diode 132 to ground. In some embodiments, the diode 132 of the lighted key 131 may enable a faster response time of the comparator 106 to detect the key press relative to R_{key} 108 of the lighted key 125. Moreover, lighted keys 131 with the diode 132 in series with the key switch 38 may enable decreased power consumption and/or heat generation of keyboard controller 46 and shared matrix 48 relative to lighted keys 125 with R_{key} 108 in series with the key switch 38.

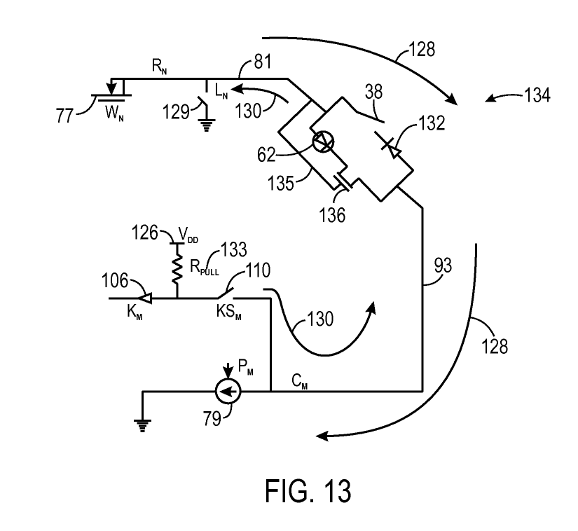

Diodes primarily permit current to flow in the forward direction, (e.g., first direction 128 through the LED 62, second direction 130 through the diode 132); however, a relatively small leakage current may flow in the reverse direction. FIG. 13 illustrates an embodiment of a lighted key 134 with a bypass path 135 around the LED 62. During the driving interval 122, a bypass switch 136 is open to enable the driving current to flow in the first direction 128 and drive the LED 62. When the lighted key 134 is pressed (e.g., key switch 38 is closed) during the sensing interval 124, the bypass switch 136 closes with the key switch 38 to enable current across the lighted key 134 to bypass the LED 62 to ground. The bypass switch 136 may substantially reduce or prevent any leakage current from passing through the LED 62 in the second direction 130. Reducing the leakage current in the reverse direction through a diode (e.g., LED 62) may reduce wear and increase the useful life of the diode.

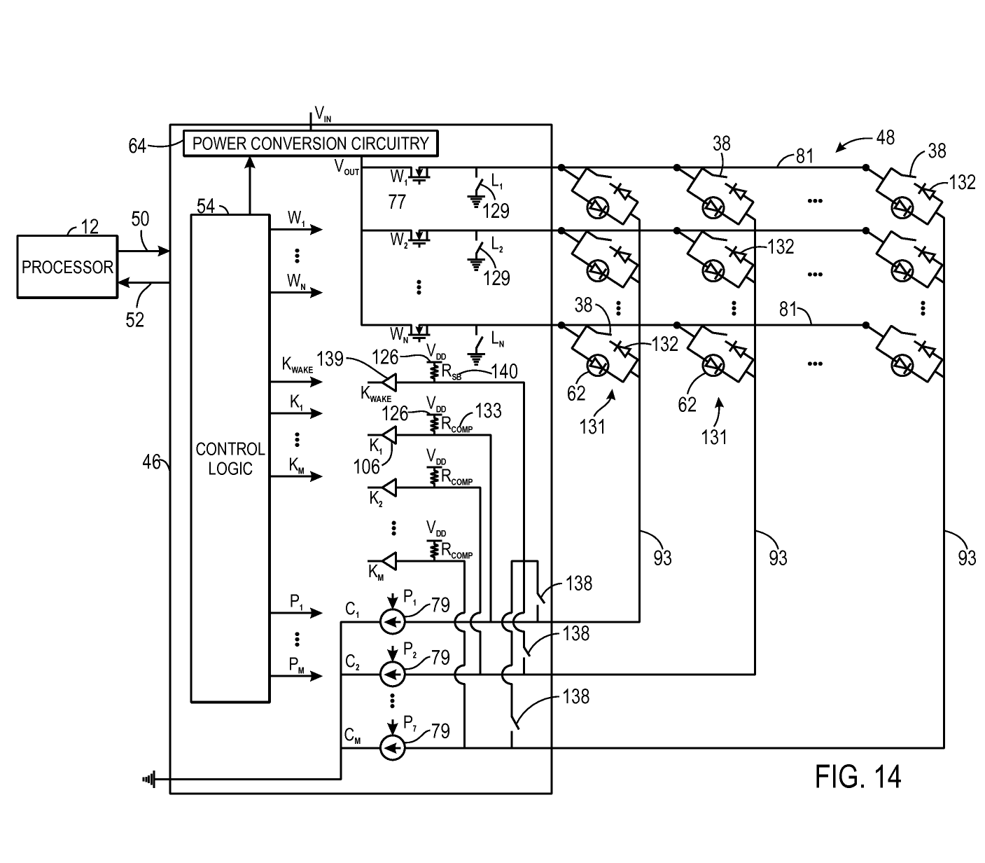

During operation of the electronic device 10, the electronic device 10 may enter a standby mode or sleep state, such as after a period of inactivity or user selection of the standby mode. Power consumption by the electronic device 10 and keyboard 22 during standby mode may be reduced by powering down the lights 62 for the keys 38, reducing an operating speed of the processor 12, turning off the display 18, or any combination thereof. As may be appreciated, the standby mode enables the operator to wake the electronic device 10 and resume full operation of the electronic device 10 faster than turning on the electronic device 10 from an OFF state. FIG. 14 illustrates an embodiment in which the keyboard 22 may be wakened from a standby mode upon any key press.

To detect any key press, the shared column lines 93 of the lighted keys 131 are shorted together in the standby mode by standby switches 138, and each of the shared row lines 81 of the lighted keys 131 is connected to ground via the respective line switches 129. In some embodiments without shared row lines 81 and/or shared column lines 93, the column lines 71 of the key switches 38 are shorted together in the standby mode by the standby switches 138, and/or each of the row lines 69 of the key switches is connected to ground via the respective line switches 129. The standby switches 138 are connected to a wake comparator 139. In the standby mode, the voltage signal at the wake comparator 139 is pulled up to V_{DD} 126 (e.g., V_{IN}, V_{OUT}) by a standby resistor 140 (R_{SB}) until a key switch 38 is closed. The wake comparator 139 may detect when any lighted key 131 is pressed because any closed key switch 38 draws a current across the standby resistor 140 to reduce the voltage signal at the wake comparator 139. The resistance of R_{SB} 140 may be relatively large (e.g., approximately 5 kΩ, 10 kΩ, 20kΩ, or more) to limit the current flow in the second direction 130 (e.g., reverse-bias) through the LEDs 62 in standby mode.

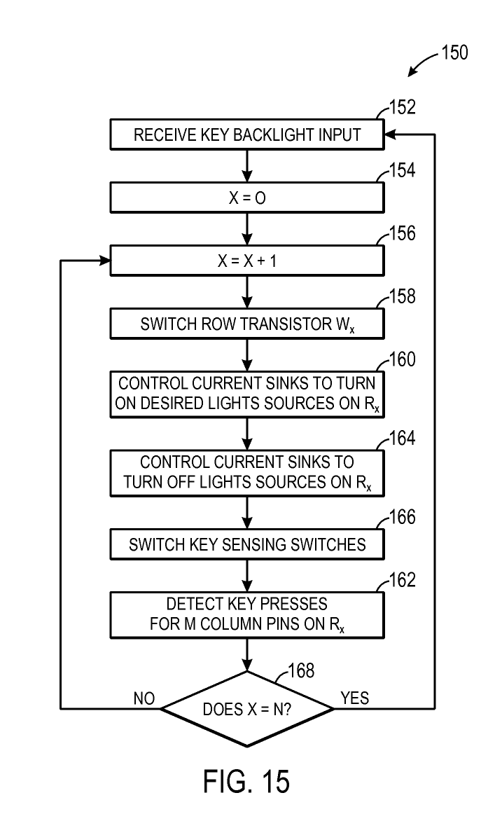

The flowchart of FIG. 15 illustrates an embodiment of a method 150 of operating the keyboard controller 46 to address the keys 38 and LEDs 62 of the shared matrix 48. At block 152, the keyboard controller 46 receives key backlight input that the control logic 54 utilizes to determine which LEDs 62 to turn on during the scanning period. For example, the key backlight input may direct the control logic 54 to backlight all the keys 38, or a subset of keys 38. In some embodiments, the subset of keys 38 may be letters, consonants, vowels, punctuation, numbers, commands (e.g., return, backspace, home, end), arrow keys, or function keys. The keyboard controller 46 addresses the shared matrix 48 by rows. At the beginning of each scanning period 82, the keyboard controller 46 resets a row counter (e.g., X=0) at block 154. The keyboard controller 46 may address each row sequentially. At block 156, the keyboard controller 46 increases (e.g., X=X+1) the row counter to address the next row of keys 38 and LEDs 62.

To address each row, the control logic 54 switches on the row transistor W_{X} at block 158 to address the row pin Rx. The control logic 54 addresses each row pin during a row interval 84. During the row interval 84, the control logic 54 controls current sinks P₁-P_{M} at block 160 to turn on the light sources (e.g., LEDs 62) based on the key backlight input for the addressed row pin R_{X}, where M is the quantity of column pins 76 and light sources per row pin Rx. The control logic 54 drives the light sources during a driving interval 122 of the row interval 84. In some embodiments, the control logic 54 detects key presses for the M column pins 76 at block 162 during the driving interval 122. In some embodiments, pressing a backlit key during the driving interval 122 may turn off the light source. In other embodiments, a key 38 may remain backlit while the key 38 is pressed.

The control logic 54 may end the driving interval 122 by controlling the current sinks P₁-P_{M} at block 164 to turn off the light sources prior to detecting key presses at block 162. At block 166, the control logic 54 may start a sensing interval 124 of the row interval 84 by changing addressing modes from driving light sources to detecting key presses. The control logic 54 may change addressing modes prior to closing key sensing switches 110 and/or to closing line switches 129. The control logic 54 may adjust the duration of the driving interval 122 and the sensing interval 124 as portions of the row interval 84. The brightness of the light sources (e.g., LEDs 62) may be proportional to the ratio of the driving interval 122 to the row interval 84. Increasing the duration of the driving interval 122 as a percentage of the duration of the row interval 84 increases the perceived brightness of the light sources. After the row interval 84 elapses, the control logic 54 determines at node 168 whether the counter is equal to the quantity N of row pins. If the counter is less than the quantity N, then the control logic 54 repeats blocks 156 to 166 to address the next row pin until the scanning period has elapsed. If the counter is equal to the quantity N, then the scanning period has elapsed. The control logic 54 then returns to block 152 to receive key backlight input, resets the counter at block 154, and begins the next scanning period 82 at block 156.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. An electronic device, comprising:
a keyboard configured to provide a user input to the electronic device, wherein the keyboard comprises:
a plurality of keys arranged in a key matrix, wherein the key matrix comprises a plurality of key row lines coupled to a processor and a plurality of key column lines coupled to the processor;
a plurality of light sources configured to backlight the plurality of keys, wherein the plurality of light sources are arranged in a backlight matrix, wherein the backlight matrix comprises a plurality of backlight row lines coupled to the processor and a plurality of backlight column lines coupled to the processor; and
a keyboard controller comprising the processor, wherein the keyboard controller is configured to scan the plurality of keys to detect key presses and to drive at least one light source of the plurality of light sources, wherein the plurality of backlight row lines and the plurality of key row lines comprise a plurality of shared row lines.

2. The electronic device of claim 1, wherein the keyboard controller is configured to drive the at least one light source of the plurality of light sources based at least in part on a key backlight input.

3. The electronic device of claim 1, wherein the plurality of keys comprise a plurality of key switches and the plurality of light sources comprise a plurality of light emitting diodes (LEDs).

4. The electronic device of claim 3, wherein each key switch of the plurality of key switches is arranged in parallel with an LED of the plurality of LEDs.

5. The electronic device of claim 4, wherein each key switch of the plurality of key switches comprises a resistor with a resistance greater than approximately 1000Ω.

6. The electronic device of claim 4, wherein each key switch of the plurality of key switches comprises a diode biased in an opposite direction to the respective LED of the plurality of LEDs.

7. The electronic device of claim 1, wherein the plurality of backlight column lines and the plurality of key column lines comprise a plurality of shared column lines.

8. The electronic device of claim 1, wherein the keyboard controller comprises a plurality of comparators configured to detect when a key of the plurality of keys is pressed, and the plurality of comparators are coupled to the plurality of shared columns.

9. The electronic device of claim 8, wherein the keyboard controller comprises a plurality of pull-up resistors, wherein each comparator of the plurality of comparators is coupled to a respective pull-up resistor.

10. The electronic device of claim 1, wherein the keyboard controller comprises a wake comparator coupled to the plurality of key column lines, wherein the wake comparator is configured to detect when any key of the plurality of keys is pressed.

11. The electronic device of claim 1, wherein the keyboard controller is configured to drive at least one light source of the plurality of light sources during a driving interval and to scan the plurality of keys during a sensing interval, wherein the driving interval is separate from the sensing interval.

12. The electronic device of claim 11, wherein the keyboard controller is configured to adjust the brightness of the light source of the plurality of light sources by adjusting a driving duration of the driving interval to a sensing duration of the sensing interval.

13. The electronic device of claim 1, wherein the keyboard controller is configured to drive a first light source of the plurality of light sources to backlight a first key regardless of whether the first key is pressed.

14. A system, comprising:
a shared matrix comprising:
a plurality of key pairs arranged on a plurality of row lines and a plurality of column lines, wherein each key pair comprises a key switch and a light source;
a plurality of shared row pins, wherein each shared row pin is coupled to key pairs of the plurality of key pairs that are arranged on a row line of the plurality of row lines;
a plurality of shared column pins, wherein each shared column pin is coupled to key pairs of the plurality of key pairs that are arranged on a column line of the plurality of column lines; and
a keyboard controller coupled to the shared matrix by the plurality of shared row pins and the plurality of shared column pins, wherein the keyboard controller is configured to address the plurality of shared row pins during a scanning period, wherein the scanning period comprises a row interval for each shared row pin and corresponding row line, and during the respective row intervals the keyboard controller is configured to detect when a key switch of the key pairs coupled to the shared row pin is closed and to drive a light source of the key pairs coupled to the shared row pin based on a key backlight input.

15. The system of claim 14, wherein the plurality of light sources comprise a plurality of light emitting diodes (LEDs).

16. The system of claim 14, wherein the light source and the switch of each key pair are coupled in parallel between a row line and a column line.

17. The system of claim 16, wherein light source of each key pair is configured to remain turned on when the switch of the respective key pair is closed.

18. The system of claim 16, wherein the switch of at least one key pair comprises a resistor or a reverse-bias diode.

19. The system of claim 14, wherein each row interval comprises a driving interval and a sensing interval, wherein the keyboard controller is configured to drive a light source of the key pairs arranged on the corresponding row line during the driving interval, and the keyboard controller is configured to detect when a key switch of the key pairs arranged on the corresponding row line is closed during the sensing interval.

20. A method for operating a backlit computer keyboard, comprising:
receiving a key backlight input, wherein the key backlight input comprises driving instructions for a plurality of light sources arranged to individually backlight a plurality of keys of the computer keyboard; and
addressing a shared matrix of key pairs, wherein each key pair comprises a light source of the plurality of light sources and a key of the plurality of keys, wherein each key pair is coupled to a row pin of a plurality of row pins and to a column pin of a plurality of column pins, and wherein addressing the shared matrix of key pairs comprises:
controlling the plurality of light sources based at least in part on the key backlight input; and
detecting key presses of the plurality of keys.

21. The method of claim 20, wherein addressing the shared matrix of key pairs comprises addressing each row pin of the plurality of row pins in row intervals and controlling current sinks on the plurality of column pins to control the plurality of light sources arranged on a row pin during a respective row interval.

22. The method of claim 21, wherein the current sinks on the plurality of column pins are controlled during a driving interval, and key presses of the plurality of keys on the plurality of column pins are detected during a sensing interval, and each respective row interval comprises the driving interval and the sensing interval.

23. The method of claim 22, wherein addressing the shared matrix of key pairs comprises switching key sensing switches on the plurality of column pins during each respective row interval to transition between the driving interval and the sensing interval.

24. The method of claim 20, wherein the driving instructions for the plurality of light sources are based at least in part on a current user activity, ambient environment, or user control, or any combination thereof.

25. An article of manufacture comprising:
one or more tangible, machine-readable media, at least collectively comprising instructions configured to be executed by a processor of a keyboard controller, the instructions comprising instructions to:
drive a plurality of light sources arranged in a shared matrix with a plurality of keys, wherein the plurality of light sources and the plurality of keys are arranged in the shared matrix in a plurality of key pairs along a plurality of row lines and a plurality of column lines, wherein a light source of each key pair is driven based at least in part on key backlight input along a respective shared row line of the plurality of row lines and a respective shared column line of the plurality of column lines; and
monitor the plurality of keys arranged in the shared matrix to detect key presses, wherein a key press of the key of each key pair is detected along the respective shared row line and the respective shared column line.

26. The article of manufacture of claim 25, comprising instructions to address the plurality of key pairs of the shared matrix during sequential row intervals for each row line, wherein the instructions to drive the plurality of light sources occur during a driving interval of each row interval and the instructions to monitor the plurality of keys to detect key presses occur during a sensing interval of each row interval.

27. The article of manufacture of claim 26, comprising instructions to adjust a duration of each driving interval to adjust a brightness of the plurality of light sources driven during the respective driving interval.

28. The article of manufacture of claim 25, comprising instructions to wake a device coupled to the keyboard controller in response to detection of a key press of any key of the plurality of keys.

29. An electronic device, comprising:
a keyboard configured to provide a user input to the electronic device, wherein the keyboard comprises:
a plurality of keys arranged in a key matrix, wherein each key of the plurality of keys is coupled to a respective key press comparator configured to detect a key press of a respective key during a scanning period, wherein the plurality of keys is coupled to a wake comparator configured to detect a key press of any key of the plurality of keys during a sleep mode and the wake comparator is configured to wake the electronic device from a standby mode based at least in part on detection of any key press.
